(19) United States
(12) Patent Application Publication
(10) Pub. No.: US 2024/0126221 A1
(43) Pub. Date: Apr. 18, 2024

(54) COMPREHENSIVE MACHINE LEARNING MODEL DEFINITION

(71) Applicant: Tektronix, Inc., Beaverton, OR (US)

(72) Inventors: John J. Pickerd, Hillsboro, OR (US); Mark Anderson Smith, Portland, OR (US); Sunil Mahawar, Portland, OR (US)

(73) Assignee: Tektronix, Inc., Beaverton, OR (US)

(21) Appl. No.: 18/482,765

(22) Filed: Oct. 6, 2023

Related U.S. Application Data
(60) Provisional application No. 63/415,588, filed on Oct. 12, 2022.

(51) Int. Cl. G05B 13/02

(52) U.S. Cl. CPC G05B 13/027

(57) ABSTRACT

A manufacturing system has a machine learning (ML) system having one or more neural networks and a configuration file associated with a trained neural network (NN), a structured data store having interfaces to the ML system a test automation application, a training store, a reference parameter store, a communications store, a trained model store, and one or more processors to control the data store to receive and store training data, allow the ML system to access the training data to train the one or more NNs, receive and store reference parameters and to access the reference parameters, receive and store prediction requests for optimal tuning parameters and associated data within the communication store, to provide requests to the ML system, allow the ML system to store trained NNs in the trained models store, and to recall a selected trained NN and provide the prediction to the test automation application.

### CROSS-REFERENCE TO RELATED APPLICATIONS

This disclosure claims benefit of U.S. Provisional Application No. 63/415,588, titled “COMPREHENSIVE MACHINE LEARNING MODEL DEFINITION,” filed on Oct. 12, 2022, the disclosure of which is incorporated herein by reference in its entirety.

### TECHNICAL FIELD

This disclosure relates to testing of electronic devices and more specifically to systems and methods for developing machine learning models for testing and measurement of electronic devices.

### BACKGROUND

U.S. patent application Ser. No. 17/951,064, filed Sep. 22, 2022, titled “SYSTEM AND METHOD FOR DEVELOPING MACHINE LEARNING MODELS FOR TESTING AND MEASUREMENT,” hereinafter “the '064 application,” the contents of which are hereby incorporated by reference into this disclosure, describes systems and methods to enable easy and rapid experimentation, prototyping, and development of machine learning models for use in test and measurement systems. The machine learning models created using such development platforms or toolkits may be used in test and measurement systems for many different purposes. Typically, one main use is to perform measurements on a signal of interest from a device under test (DUT), such as predicting a Transmitter Dispersion Eye Closure Quaternary (TDECQ) measurement for an optical transceiver, for example.

### BRIEF DESCRIPTION OF THE DRAWINGS

FIG. 1 shows a user interface depicting a block diagram of a test automation application and a machine learning system within a manufacturing test environment.

FIG. 2 shows a block diagram of an embodiment of a manufacturing system having a shared structured data store between a test automation application and a machine learning system.

FIG. 3 shows a block diagram of an embodiment of a manufacturing system having a shared structured data store between a test automation application and a machine learning system, including a global store portion and a local store portion.

FIGS. 4 and 5 show embodiments of configurations of a manufacturing system.

### DETAILED DESCRIPTION

Embodiments herein enhance the performance and capabilities of the systems and methods described in the '064 application. The discussion of the embodiments herein may refer to a machine learning model development system as OptaML™ “ML Tools” application or software. The ML Tools software operates in conjunction with a structured data store, and interfaces with customers' automation software used in testing devices under test (DUT) on manufacturing lines.

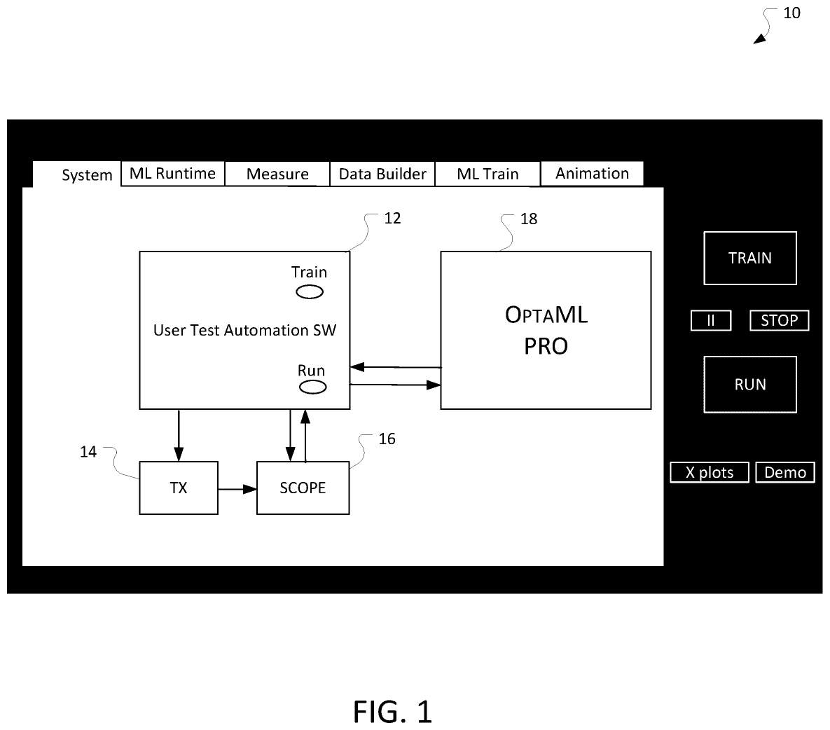

FIG. 1 shows an embodiment of a user interface 10 that shows components of a manufacturing system. A System tab menu depicts a high-level block diagram view of an overall optical tuning system. The system comprises the User (or customer) Test Automation software application used on the manufacturing line 12, an oscilloscope (Scope), or other test and measurement instrument, 16 to acquire data such as waveforms (wfms), and the OptaML™ Pro machine learning assisted tuning prediction software, or “ML Tools” 18. The example embodiment of an optical transmitter tuning system also includes the transmitter or other DUT undergoing tuning and testing 14.

The following discussion uses the example context of an optical transmitter/transceiver tuning system, and will refer to an OptaML™ Pro application which, working in conjunction with a user's test automation software, predicts transmitter tuning parameters. The example of an optical tuning environment serves as an example with limitation to that environment. The discussion uses the system configured for training of tuning parameters for a user's device under test. This may be applied to multiple applications such as optical transmitters and their tuning parameters using waveform data as input to the deep learning networks after being transformed into some form of tensor. Another example would be where the system may be used in wireless communications market for robot tuning of cavity filters in diplexers where S-parameters are converted to tensors for inputs to the deep learning networks.

It should be noted that this general system may be adapted to other applications which are not tuning DUT parameters but rather just making measurements, or classifications of outputs from the DUT. Therefore, the exact folder structure make up of the Folder Model can be modified while keeping the same general concepts incorporated and therefore fall within the claims of this invention.

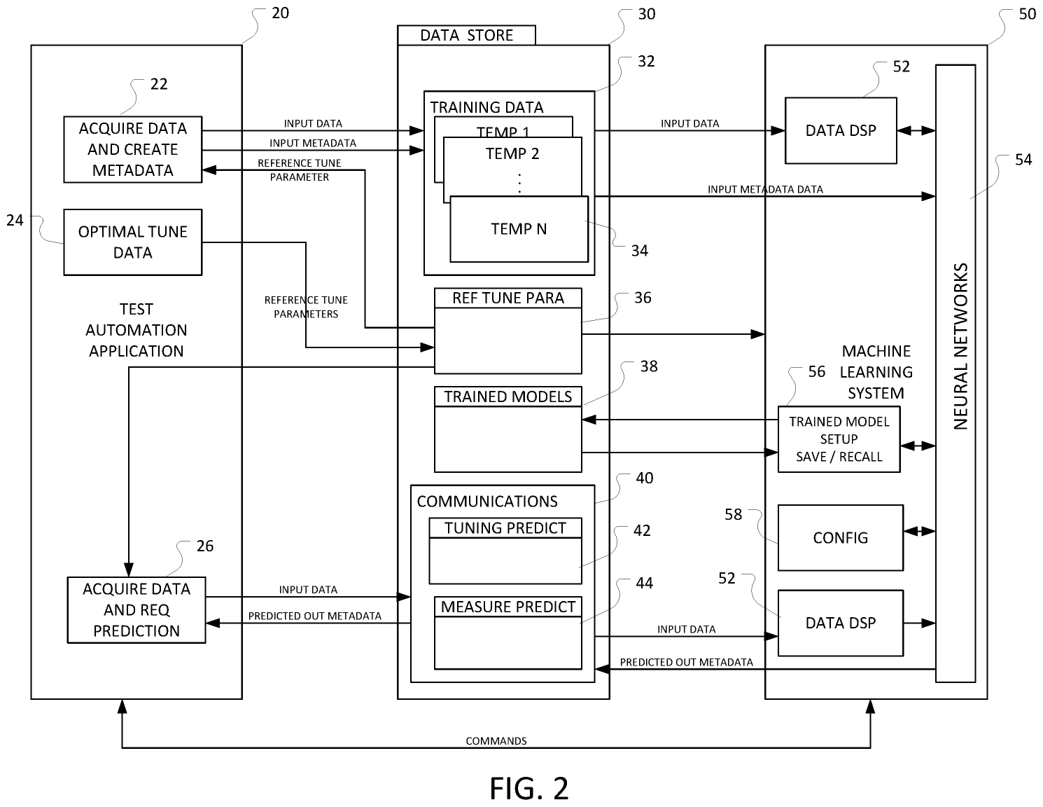

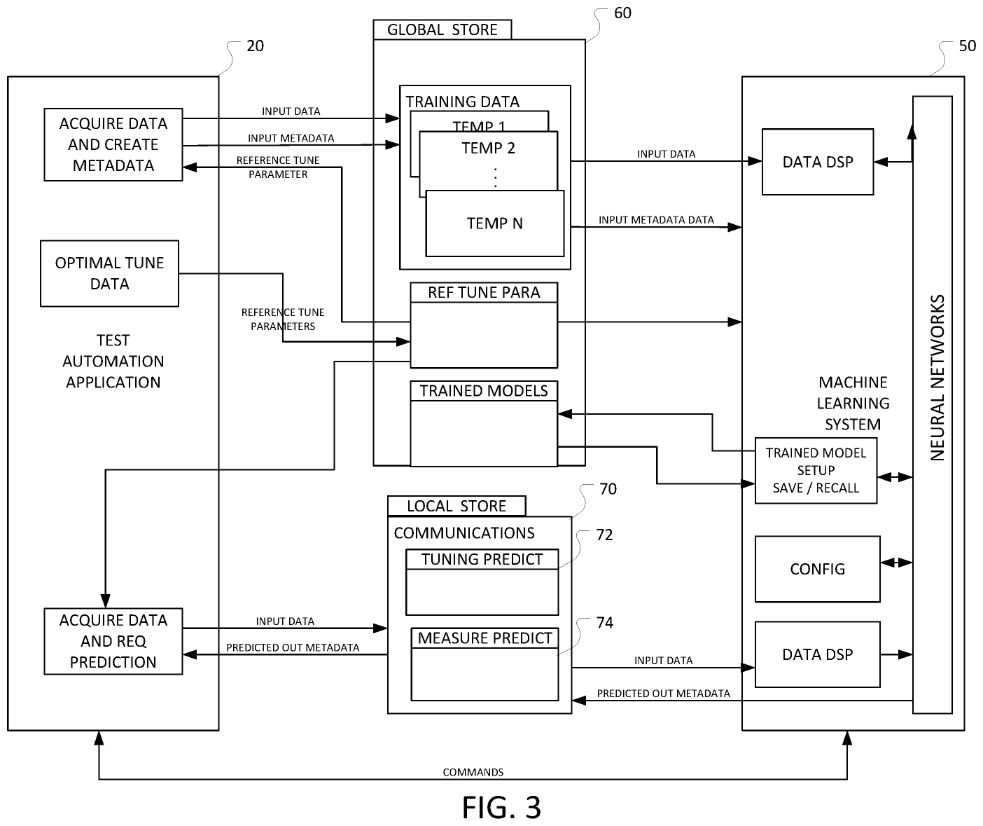

The structured data store used as part of the ML Tools application meets several objectives, including maintaining consistency between training requirements and runtime prediction requirements. The structured data store also provides the necessary features to interface between the user's custom automation test software application and the Tektronix OptaML ML Tools environment SW application. The structured data store maintains past training data which can be augmented with more data for potential future training updates. This also supports quick and easy future training updates and supports multiple trained models that a customer may choose to build. All phases of process control such as training, prediction, and validation pass thru this folder structure which is the interface structure between the user automation software and the ML tools software. The structure of the data store includes different information stored in it that may have a hierarchy. One could view this as a folder structure, with main folders, and the main folders having subfolders. This will become clearer with reference to FIGS. 2 and 3.

Overall, the system has the three components 12, 16, and 18 shown in FIG. 1. The customer designs and writes the user's automation software 12. In this example, it controls the manufacturing line for tuning the optical transmitters. This involves controlling ovens, optical switches, test, and measurement instruments such as scope 16, and the ML Tools application 18.

In the overall process, the ML Tools application 18, OptaML™ Pro, requires a training period that involves the customer collecting, formatting, and storing the data in the structure store. The system uses the data for training the neural networks to make tuning parameter predictions based on input waveforms from the transmitter. After training, the User Automation SW stores three sets of reference parameters into transmitters to be tuned, and collects three waveforms, one for each reference parameter in the tuning. These three waveforms go into a tensor builder block, discussed in more detail in FIGS. 2 and 3, which creates an RGB image representation of pruned data within the acquired waveforms. This becomes the input to the neural networks that then output a set of optimal tuning parameters for the transmitter.

The User Automation SW then loads the transmitter with the predicted tuning parameters and controls the scope to acquire one waveform. This waveform will be tested with measurements such as TDECQ (transmitter dispersion eye closure quaternary), OMA (optical modulator amplitude), and others to determine pass or fail. If the ML prediction fails, then the logic in system makes it easy for the user to run their tuning algorithm to attempt tuning. If that fails, then the device is rejected.

The block diagrams shown in FIGS. 2 and 3 illustrate aspects of the embodiments. The Data Store 30 presents the full data store implemented as a single local store in each computing device on which the application runs as shown in FIG. 2, or as split global store 60, and local store 70 as shown in FIG. 3. This folder would be contained in a master folder belonging to the customer. That master folder may contain multiple trained model folders for different models of their products for which they may want to make predictions.

The overall system consists of three primary components, which are the Customer/User Test Automation System 20, or application, the Data Store 30, and the ML Tools machine learning system 50, or application. All three components are required for the trained model to be used. Other external software cannot use the trained model 38. Use of the trained model requires both ML Tools application 50, and the customer's software application 20 operating as the system master controller.

In FIG. 2, the customer automation software or system 20 is written and maintained by the customer. It acts as the master manufacturing controller software. It controls ovens, optical switches, oscilloscopes, ML Tools SW application, and potentially other components. Its responsibilities include controlling the DUT and measurement instruments to collect waveforms, S-parameters, or other data from DUTs to use for training the ML Tools Application neural networks. They also include the tasks to define the metadata which the neural networks will predict and/or associate with the collected DUT data. Another responsibility involves collecting all training data, formatting it with predefined naming conventions, and placing it in pre-defined data store locations. In one embodiment, the customer automation system also will place training metadata into data files of a more universal format, such as *.csv files. During run time it collects data from the DUT and controls the process of providing it to the ML Tools application to receive a tuning or measurement prediction.

The customer automation system application 20 will have many other components than those shown in FIGS. 2 and 3. These figures do show some basic blocks required for implementation of a DUT tuning system with machine learning assistance using the ML Tools SW application.

The Acquire Data block 22 collects the necessary data from DUTs for training the deep learning networks in the ML Tools Application SW. It then stores the data and metadata in the data store. In one embodiment, the training data portion of store 32 may store the data in a structure with a folder or other designated area such as 34 for each temperature at which the DUTs are tested.

The customer system will be configured to sample many DUT devices and determine their optimal tuning using the customer's standard tuning process for the DUTs at 24. Once that occurs, it creates the reference tuning parameter sets that are needed for training and for runtime predictions. This block then stores the reference parameters sets in the data store at 36.

During runtime, the customer's system loads reference parameters into their DUT and collects waveforms or S-parameters at 26. It then provides these as input to the ML Tools Application through the data store communication portion 40 and then receives back predicted metadata also through the communication portion of the data store. This may be a set of optimal tuning parameters stored at 42, or it may be a measurement such as TDECQ or other at 44.

As mentioned above the data store 30 acts as the interface between the Customer Automation System 20 and the ML Tools application 50. It contains all the data 32 and 36 used to train the model, the trained neural networks 38, all the ML Tools System class variables setup data for both training and predictions, and the communication folders 40, 42 and 44, for making runtime predictions.

The training data folder 32 may receive and contain input data in the form of waveform data, S-parameter data, or other data that will be used for training and input for predictions. It will contain input metadata associated with the input waveform or S-parameter data, possibly in input file such as in the *.csv files mentioned above. The ML Tools application may create animation files during the training procedure. They contain one frame of image tensor and the metadata for each of the thousands of input waveforms. The ML Tool application stores these in the data store.

The reference tuning parameters folder 36 contains three or more sets of reference tuning parameters needed for collecting training data or for collecting data in runtime prediction processes for tuning processes. The customer automation system 20 loads the reference parameter sets into the DUTs and collects three waveforms or three sets of S-parameters. The system uses these as input to the deep learning networks for training or for runtime prediction.

Once a model has been trained, the ML Tools application then creates a set up file and saves it to store, or substore, 38 of the data store 30. This file contains the trained neural networks. It also contains the setup class variable values for the entire ML Tools application for both training and for run time prediction. The user may have created more than one trained setup file model for their given DUT model. Typically, the ML Tools application will only train one model and store it in this portion. For example, perhaps a new model was trained because the DUT characteristics changed at some point in time. The ML Tools application may store the old model and the new model. Other reasons may exist why multiple trained setups could be saved.

During runtime for predictions using the trained networks, the customer automation system 20 places data from the DUT in one of the communications store 40. The data results from placing the reference tuning parameters into a DUT and a PI (programmatic interface) command or front panel button press causes ML Tools Application to make a prediction using the data as input. The ML Tools application then places the prediction back into communications store 40. A PI OK handshake may go back to the Customer Automation system, which then reads the predicted results. The communications store 40 may contain a communication folder for making DUT tuning predictions, such as 42, and a communications folder for making measurements such as 44. The communications store 40 may contain other communication folders depending on the specific system selected in the ML Tools application. Similarly, there may be other stores within the data store. Different system applications that may be implemented for selection by the user from the ML Tools System menu, may require modifications to this model filter structure.

The model is structured in a way which simplifies the procedure for the system architecture to step through processing it to create the training data arrays. This keeps all input data and all metadata consistent. As mentioned above, the data store also supports training at different values of operating parameters, such as temperature. Again, this simplifies the data processing and associations internally. This makes it easier for the customer to manage and visualize the data, giving them better insight into the nature of their DUT. One such visualization may represent temperature as a bar graph in the tensor images built for prediction and training.

An important element of the store is the trained model either saved or recalled by using a File>Recall trained setup or File Save trained setup pulldown menu or PI command. This file contains all system class variables needed for setup of the entire system application for both training and run time predictions. It also includes the trained neural networks in the system.

The various elements of the data store are represented by a structure of stores, or substores, such as folders and files. The organization of the data may include individual files as shown, or combinations of files that pull the data into different kinds of structures other than the example shown. The data store has several aspects including a single structured store containing data portable to multiple computers that run the OptaML™ ML Tools software to make tuning predictions, a set of folders to support waveform data and metadata for training the deep learning networks, and substores and files to support the specific system training and runtime prediction. These may include reference tuning parameters and an array of OptaML™ tuning parameters used to determine reference tuning parameters. The store also includes a store containing the trained model file containing trained deep learning neural networks, all system class variables states needed for training and prediction. The data store also includes communications store(s) for inputting waveforms data for making predictions from the trained networks, and for containing the predicted results. In different embodiments, the data store and substores may be organized into different hierarchies.

The ML Tools application 50 performs the required digital signal processing (DSP) 52 to transform input data to tensor structures to be used as input to train the deep learning networks or to obtain predictions from them. The ML Tools application has a Save/Recall trained model setup block 56 that saves the entire system setup including trained neural networks into one or more data stores. System configuration 58 represents all the applications class variables and neural network states needed to perform both training and runtime predictions. In one embodiment the data store 38 may comprise a single file. Alternatively, this could exist as more than one file. This block also allows for recalling and loading a saved model setup file into the system.

The DSP block mentioned above 52 contains all system DSP transforms that are needed to apply to the input data waveforms or S-parameters, and then incorporate them into a tensor format suitable for input to the deep learning network design being used. Two of them are shown in the block diagrams, but it is only one DSP block 52, the application just uses it in two different areas, in both prediction and training. This ensures that the entire system set up for both training and prediction remains consistent. Data must be processed identically for both training and prediction.

The deep learning network 54 has a Train mode and a Predict mode. There are two states of operation for the ML Tools Application to function: the train state; and the run state, making predictions using the trained networks.

Another aspect of the system ensures that each customer will have only their own models they helped train, located in the local store on each computing device in their manufacturing system, as shown in FIG. 2.

In FIG. 3, store 30 of FIG. 2 has a different structure. The store now has two components, a global store 60, that resides in a central location accessible by all the computing devices on the manufacturing line or that otherwise need access, such as all the computing devices that are running an instance of the Customer Automation application 20 and/or the ML Tools application 50. Each computing device would have a copy of the local store 70. In one embodiment, the local stores only contain the communications stores and any substores, such as the tuning prediction store 72 and the measure prediction score 74.

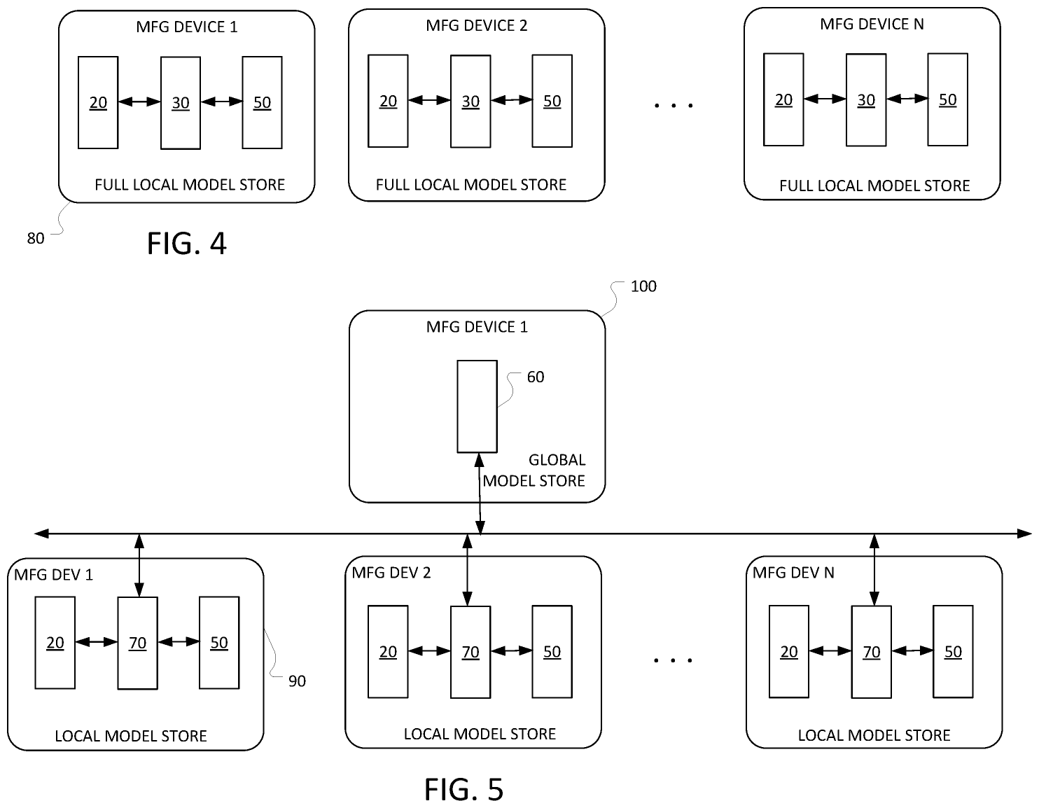

Referring to FIGS. 2 and 4, the data store exists as a single structured data store, stored on each local computer such as 80 on the manufacturing line on which the OptaML™ ML Tools SW Application is running. However, this may have a disadvantage in the replication of the entire store on all the machines on which the ML Tools Application runs in the manufacturing line. There are typically three or more gigabytes (GB) of this data.

Referring to FIGS. 3 and 5, the split between a local store and a global store may have some advantages. The training data store may only be used once for the first training and later for an updated training if the need arises. Debugging and validation processes may also use this training data should issues arise on the manufacturing line. In the configurations of FIGS. 3 and 5, it may make it more efficient and easier for the customer to manage updated trainings if the split global/local storer configuration shown in FIG. 3 is incorporated. In FIG. 5, the system has one global store 60 on a server or other centrally-located computing device 100 as the store used by all instances on the manufacturing line and there are N instances of the local store 70 on other local computing devices such as 90 on the customer manufacturing line.

The embodiments herein generally include a high-level representation of a system model trained using a customer's training data for a DUT they wish to tune or measure. The model comprises much more than just trained neural networks. A trained neural network in the context of these tuning and testing applications is not very useful unless the entire system setup is also saved as part of the model. All the DSP and tensor building algorithms used for training the neural networks are replicated during runtime on the manufacturing line for the trained neural network to make accurate predictions. In addition, the store and tools are configured into a structure that is easily portable across many machines on the line. In addition, it should easily enable it to be retrained in the event of production line component changes that affect the optimal tuning results. The embodiments retain the original training data so that the model can be easily retrained in the future, and so that it can be compared against in the event of line data changes, or other issues that might arise. Embodiments of the disclosure include a tools and store structure that addresses all these issues plus additional ones as described in the main descriptions above.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a manufacturing system, comprising: a machine learning system, the machine learning system comprising: one or more neural networks; and a configuration file comprising information associated with a trained neural network for operations; a structured data store connected to the machine learning system, the structured data store having an interface to the machine learning system and an interface to a test automation application used to test devices under test (DUTs); and one or more processors configured to execute code to cause the one or more processors to control the structured data store to: receive and store training data obtained from testing of the DUTs from the test automation application in a training store within the structured data store and allow the machine learning system to access the training data to train at least one of the one or more neural networks in the machine learning system; receive and store reference parameters for the DUTs from the test automation application in a reference parameter store and to allow the machine learning system to access the reference parameters; receive and store prediction requests for optimal tuning parameters for the DUTs and associated data from the test automation application within a communication store within the structured data store and to provide the requests to the machine learning system; allow the machine learning system to store trained ones of the one or more neural networks in a trained models store in the structured data store; and allow the machine learning system to recall a selected trained neural network and an associated configuration file and to provide one or more predictions to the test automation application.

Example 2 is the manufacturing system of Example 1, wherein the code that causes the one or more processors to control the structured data store to receive and store training data comprises code to cause the one or more processors to store input data and input metadata for training of one or more of the neural networks.

Example 3 is the manufacturing system of either of Examples 1 or 2, wherein the code that causes the one or more processor to control the structured data store to receive and store prediction requests comprises code to cause the one or more processors to receive input data from a device under test being tested by the test automation application.

Example 4 is the manufacturing system of Example 3, wherein the code that causes the one or more processor to control the structured data store to receive and store prediction requests comprises code to cause the one or more processors to allow the machine learning system to retrieve the input data and provide predicted metadata to the communication store.

Example 5 is the manufacturing system of any of Examples 1 through 4, wherein the one or more processors are further configured to provide communication between the machine learning system and the test automation application.

Example 6 is the manufacturing system of any of Examples 1 through 5, wherein the structured data store is replicated on a plurality of computing devices in the manufacturing system.

Example 7 is the manufacturing system of any of Examples 1 through 5, wherein the structured data store has a global portion stored on a global server accessible by a plurality of computing devices in the manufacturing system, and a local portion stored on the plurality of computing devices in the manufacturing system.

Example 8 is the manufacturing system of Example 7, wherein the global portion comprises the training store, the reference parameter store, and the trained models store.

Example 9 is the manufacturing system of Example 7, wherein the local portion comprises the communication store.

Example 10 is the manufacturing system of any of Examples 1 through 5, wherein at least the trained neural networks trained by data from the test automation application reside on a plurality of computing devices in the manufacturing system.

Example 11 is the manufacturing system of any of Examples 1 through 5, wherein at least one of the one or more processors reside in the machine learning system to execute code to train one or more of the neural networks and to deploy the one or more neural networks to make predictions for the test automation application.

Example 12 is the manufacturing system of Example 11, wherein the at least one of the one or more processors is further configured to generate a tensor array and perform feature extraction on both the training data and the input data for predictions during deployment, providing consistency for both training and run time.

Example 13 is the manufacturing system of any of Examples 1 through 5, the structured data store comprising: a training data store, the training data store having substores for each value of a testing parameter for a device under test; a reference parameter store to store reference parameters and waveforms associated with reference parameters acquired from the device under test; a trained models store to store one or more trained neural networks, class variables and other configuration information for the trained neural network; and a communications store to store information received from the test automation application and from the machine learning system, the communications store configured to allow the test automation application and the machine learning system to access the information.

Example 14 is a method comprising: receiving and storing training data obtained from testing DUTs from a test automation application in a training store within a structured data store; accessing the training store to retrieve the training data and using the training data to train one or more neural networks in a machine learning system; storing one or more trained neural networks and a configuration file in the structured data store; receiving and storing reference parameters for the DUTs from the test automation application in a reference parameter store; accessing the reference parameter store to retrieve the reference parameters and using the reference parameters to produce optimal tuning parameters for the DUTs; storing the optimal tuning parameters in the structured data store; and allowing the test automation application to retrieve the optimal tuning parameters.

Example 15 the method of Example 14, further comprising: receiving and storing S-parameters obtained from the DUTs by the test automation application in the structured data store; accessing the structured data store to retrieve the S-parameters and using the S-parameters to produce predicted performance parameters for the DUTs; and storing the predicted performance parameters in the structured data store.

Example 16 is the method of either of Examples 14 or 15, further comprising allowing the machine learning system to only access trained models developed in the machine learning system.

Example 17 is the method of any of Examples 14 through 16, further comprising: storing the training data, the reference parameters, and the trained neural networks in a centrally located global store; and storing prediction requests and prediction data in a local store on each of a plurality of local computing devices in a manufacturing system.

Example 18 is the method of any of Examples 14 through 17, further comprising storing the training data, reference parameters, trained neural networks, and optimal tuning parameters in a centrally located global store.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific examples of the invention have been illustrated and described for purposes of illustration, it will be understood that various modifications may be made without departing from the spirit and scope of the invention. Accordingly, the invention should not be limited except as by the appended claims.

1. A manufacturing system, comprising:
a machine learning system, the machine learning system comprising:
one or more neural networks; and
a configuration file comprising information associated with a trained neural network for operations;
a structured data store connected to the machine learning system, the structured data store having an interface to the machine learning system and an interface to a test automation application used to test devices under test (DUTs); and
one or more processors configured to execute code to cause the one or more processors to control the structured data store to:
receive and store training data obtained from testing of the DUTs from the test automation application in a training store within the structured data store and allow the machine learning system to access the training data to train at least one of the one or more neural networks in the machine learning system;
receive and store reference parameters for the DUTs from the test automation application in a reference parameter store and to allow the machine learning system to access the reference parameters;
receive and store prediction requests for optimal tuning parameters for the DUTs and associated data from the test automation application within a communication store within the structured data store and to provide the requests to the machine learning system;
allow the machine learning system to store trained ones of the one or more neural networks in a trained models store in the structured data store; and
allow the machine learning system to recall a selected trained neural network and an associated configuration file t and to provide one or more predictions to the test automation application.

2. The manufacturing system as claimed in claim 1, wherein the code that causes the one or more processors to control the structured data store to receive and store training data comprises code to cause the one or more processors to store input data and input metadata for training of the one or more of the neural networks.

3. The manufacturing system as claimed in claim 1, wherein the code that causes the one or more processors to control the structured data store to receive and store prediction requests comprises code to cause the one or more processors to receive input data from a DUT being tested by the test automation application.

4. The manufacturing system as claimed in claim 3, wherein the code that causes the one or more processor to control the structured data store to receive and store prediction requests comprises code to cause the one or more processors to allow the machine learning system to retrieve the input data and provide the one or more predictions metadata to the communication store.

5. The manufacturing system as claimed in claim 1, wherein the one or more processors are further configured to provide communication between the machine learning system and the test automation application.

6. The manufacturing system as claimed in claim 1, wherein the structured data store is replicated on a plurality of computing devices in the manufacturing system.

7. The manufacturing system as claimed in claim 1, wherein the structured data store has a global portion stored on a global server accessible by a plurality of computing devices in the manufacturing system, and a local portion stored on the plurality of computing devices in the manufacturing system.

8. The manufacturing system as claimed in claim 7, wherein the global portion comprises the training store, the reference parameter store, and the trained models store.

9. The manufacturing system as claimed in claim 7, wherein the local portion comprises the communication store.

10. The manufacturing system as claimed in claim 1, wherein at least the trained neural networks trained by data from the test automation application reside on a plurality of computing devices in the manufacturing system.

11. The manufacturing system as claimed in claim 1, wherein at least one of the one or more processors reside in the machine learning system to execute code to train one or more of the neural networks and to deploy the one or more neural networks to make predictions for the test automation application.

12. The manufacturing system as claimed in claim 11, wherein the at least one of the one or more processors is further configured to generate a tensor array and perform feature extraction on both the training data and the input data for predictions during deployment, providing consistency for both training and run time.

13. The manufacturing system as claimed in claim 1, wherein the structured data store comprises:
a training data store, the training data store having substores for each value of a testing parameter for a device under test;
a reference parameter store to store reference parameters and waveforms associated with reference parameters acquired from the device under test;
a trained models store to store one or more trained neural networks, class variables and other configuration information for the trained neural network; and
a communications store to store information received from the test automation application and from the machine learning system, the communications store configured to allow the test automation application and the machine learning system to access the information.

14. A method comprising:
receiving and storing training data obtained from testing DUTs from a test automation application in a training store within a structured data store;
accessing the training store to retrieve the training data and using the training data to train one or more neural networks in a machine learning system;
storing one or more trained neural networks and a configuration file in the structured data store;
receiving and storing reference parameters for the DUTs from the test automation application in a reference parameter store;
accessing the reference parameter store to retrieve the reference parameters and using the reference parameters to produce optimal tuning parameters for the DUTs;
storing the optimal tuning parameters in the structured data store; and
allowing the test automation application to retrieve the optimal tuning parameters.

15. The method as claimed in claim 14, further comprising:
receiving and storing S-parameters obtained from the DUTs by the test automation application in the structured data store;
accessing the structured data store to retrieve the S-parameters and using the S-parameters to produce predicted performance parameters for the DUTs; and
storing the predicted performance parameters in the structured data store.

16. The method as claimed in claim 14, further comprising allowing the machine learning system to only access trained models developed in the machine learning system.

17. The method as claimed in claim 14, further comprising:
storing the training data, the reference parameters, and the trained neural networks in a centrally located global store; and
storing prediction requests and prediction data in a local store on each of a plurality of local computing devices in a manufacturing system.

18. The method as claimed in claim 14, further comprising storing the training data, reference parameters, trained neural networks, and optimal tuning parameters in a centrally located global store.
